(19) United States
(12) Patent Application Publication
(10) Pub. No.: US 2007/0214654 A1
(43) Pub. Date: Sep. 20, 2007

(54) Electric hair clipper structure

(76) Inventors: Cheng-Hsiang Chen, Xinzhuang City (TW); Yu-Hsia Chen Yang, Xinzhuang City (TW)

Correspondence Address: Troxell Law Office Pllc, Suite 1404, 5205 Leesburg Pike, Falls Church, VA, 22041, US

(21) Appl. No.: 11/378,370

(22) Filed: Mar. 20, 2006

(51) Int. Cl. B26B 19/02

(52) U.S. Cl. 30/210; 30/223

(57) ABSTRACT

The present invention provides a shearing tool set formed on a front end of a housing. The shearing tool set comprises a stationary blade and a vibratory base having a moving blade, wherein the stationary blade is positioned at a suitable location on an exterior of the vibratory base such that the moving blade forms a superimposed structure on the stationary blade. The vibratory base is driven by motor inside the housing such that the moving blade and the stationary blade form cross-over displacements, and continuous gaps are provided on a suitable location on an internal surface of each saw-tooth on the respective cutting edges of the stationary blade and the moving blade. When the gaps on the stationary blade converge relative to the gaps on the moving blade, a temporary space is formed for holding hair, thereby preventing the hair from sliding during shearing and affecting the shearing effects.

### BACKGROUND OF THE INVENTION

(a) Field of the Invention

The present invention relates to an electric hair clipper structure, more particularly, to a shearing tool structure that is capable of reducing the negative impact of hair sliding movements on hair shearing effects.

(b) Description of the Prior Art

Nowadays, the majority of barber shops use electric hair clippers for haircut, especially for cutting longer hair. A suitable shearing tool set is provided on a front end of the majority of electric hair clippers on sale in the market. The shearing tool set comprises a stationary blade and a moving blade, wherein the moving blade is connected to a linkage inside a vibratory base whereas the stationary blade is provided on a suitable location on the vibratory base, such that the moving blade forms a superimposed structure on the stationary blade. Then triangular saw-tooth cutting edges are configured at front edges of the moving blade and the stationary blade such that the relative displacements of the horizontally vibrating moving blade result in the formation of a plurality of small scissor-shaped patterns for cutting hair. However, referring to FIG. 1, when a barber sets a conventional electric hair clipper a into action, and when a cutting edge a1 comes into contact with a longer hair b, the hair b that enters into the cutting edge a1 is sometimes pushed outward along an outline of the cutting edge a1 when the cutting edge a1 is pushed at a higher speed, because of greater movability of the longer hair b and the outward, straight opening of the cutting edge a1, thereby greatly affecting the shearing effects or speed and making the barber hard to control the shearing speed, which is to be improved.

To overcome the abovementioned drawbacks, the applicant of the present invention has designed an innovative electric hair clipper structure, wherein the hair becomes fixed inside the continuous gaps formed at a suitable location on the cutting edges during shearing, thereby preventing hair from sliding and facilitating shearing.

### SUMMARY OF THE INVENTION

It is the primary object of the present invention to provide an improved blade structure for a shearing tool set that is more convenient and is capable of reducing the negative impact of hair sliding movements on hair shearing effects.

To achieve the abovementioned object, the present invention provides a shearing tool set formed on a front end of a housing. The shearing tool set comprises a stationary blade and a vibratory base having a moving blade, wherein the stationary blade is positioned at a suitable location on an exterior of the vibratory base, such that the moving blade forms a superimposed structure on the stationary blade. The vibratory base is driven by a motor inside the housing such that the moving blade and the stationary blade form cross-over displacements, wherein triangular saw-tooth cutting edges are configured at front edges of the moving blade and the stationary blade, and continuous gaps are provided on a suitable location on an internal surface of each saw-tooth on the respective cutting edges of the stationary blade and the moving blade. The plurality of gaps can be in the shape of a semicircle, a triangle, or a square.

When using the above structure, the moving blade continuously makes crossover displacements with the stationary blade. When the gap on the stationary blade corresponds to the gap on the moving blade, a temporary space for holding hair is formed, such that when the barber sets the electric hair clipper into action again, the hair will not slide along with the shearing tool set, thereby completing a haircut by the displacements of blades within a short time period. The advantages of the present invention are the convenience in using it and better shearing effects than those of conventional shearing tool sets. Therefore, the present invention is deemed competitive.

To enable a further understanding of the objectives and the technological methods of the invention herein, the brief description of the drawings below is followed by the detailed description of the preferred embodiments.

### BRIEF DESCRIPTION OF THE DRAWINGS

FIG. 1 shows a schematic view of the application of a conventional electric hair clipper.

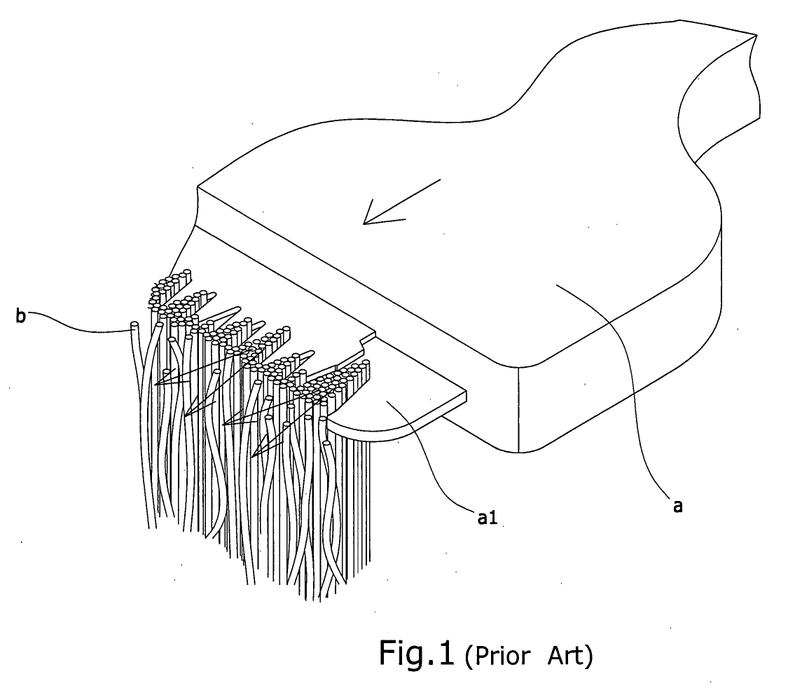

FIG. 2 shows a structural perspective view of the present invention.

FIG. 3 shows a structural schematic view of the shearing tool set of the present invention.

FIG. 4 shows a first enlargement of the cutting edges of the shearing tool set according to the present invention.

FIG. 5 shows a second enlargement of the cutting edges of the shearing tool set according to the present invention.

FIG. 6 shows a third enlargement of the cutting edges of the shearing tool set according to the present invention.

FIG. 7 shows a schematic view of the application of the present invention.

### DETAILED DESCRIPTION OF THE PREFERRED EMBODIMENTS

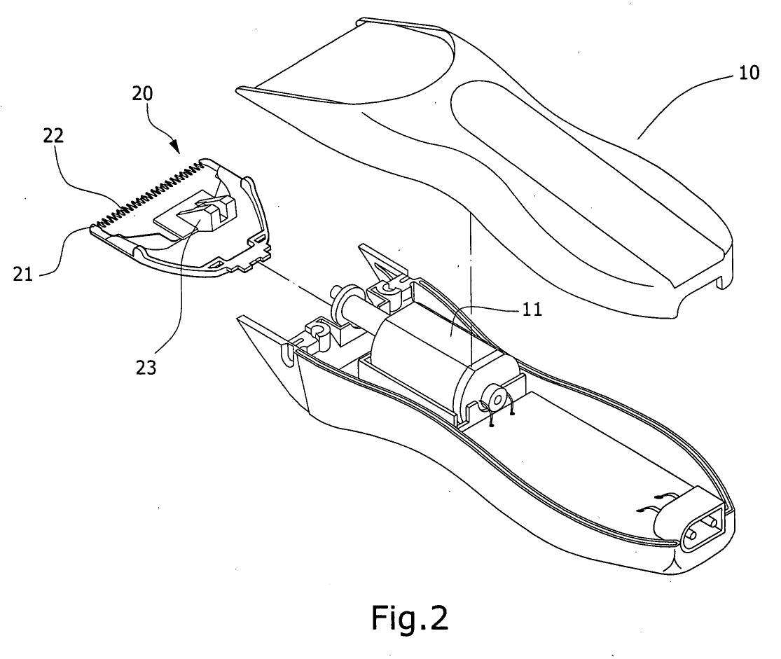

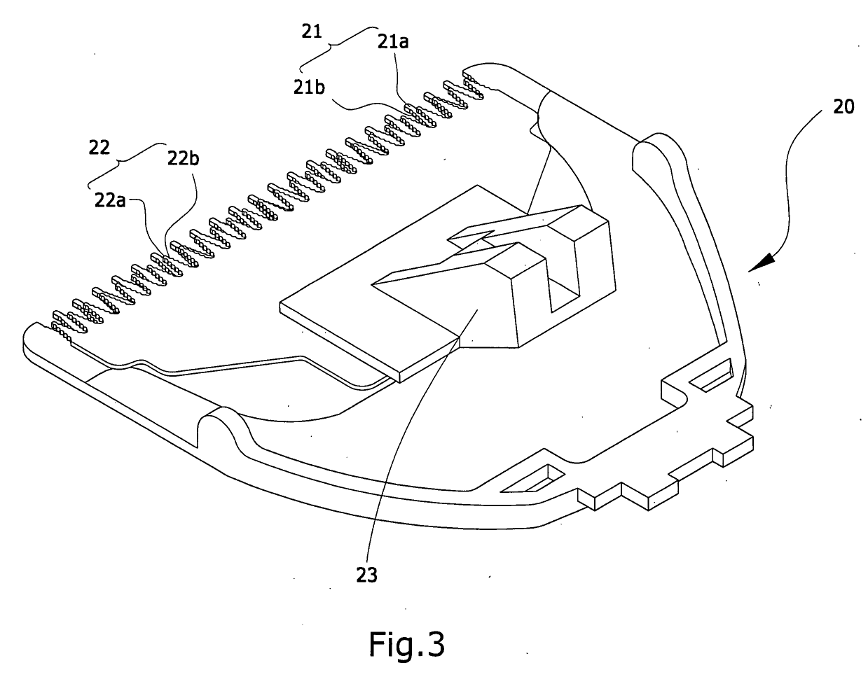

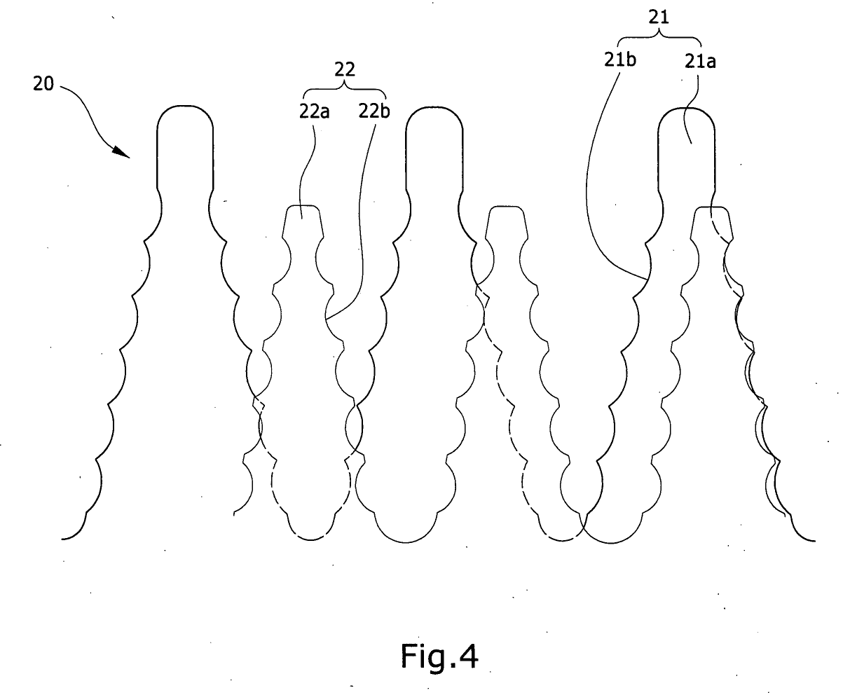

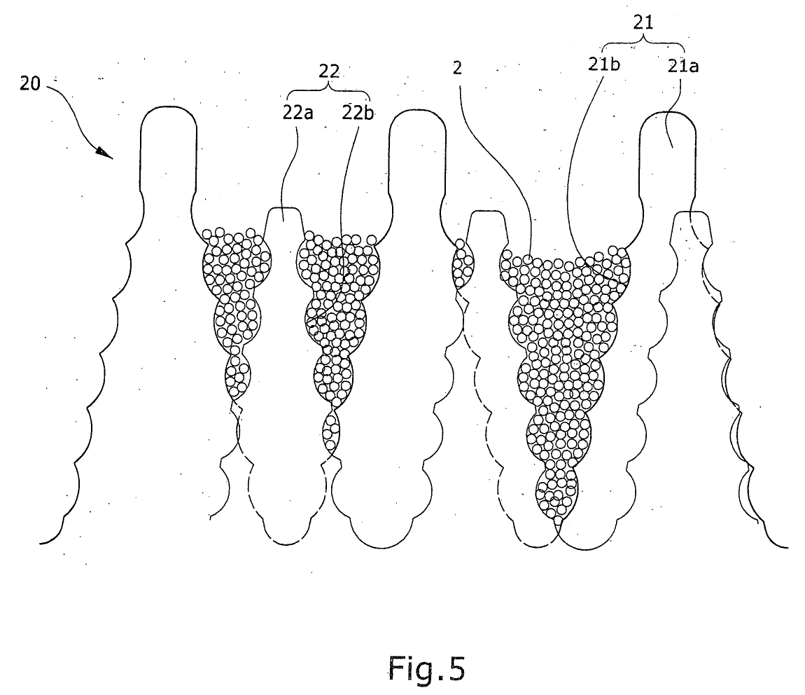

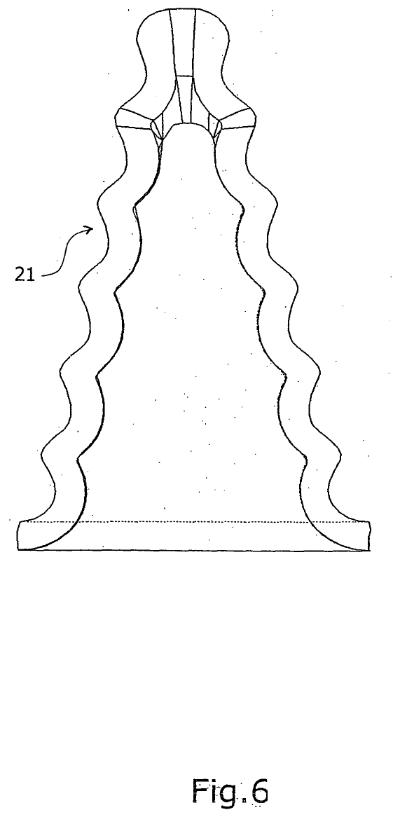

Referring to FIG. 2 to FIG. 6, the present invention provides a shearing tool set 20 formed on a front end of a housing 10. The shearing tool set 20 comprises a stationary blade 21 and a vibratory base 23 having a moving blade 22, wherein the stationary blade 21 is positioned at a suitable location on an exterior of the vibratory base 23 such that the moving blade 22 forms a superimposed structure on the stationary blade 21. The vibratory base 23 is driven by a motor 11 inside the housing 10 such that the moving blade 22 and the stationary blade 21 form cross-over displacements, wherein triangular saw-tooth cutting edges 21a and 22a are configured at front edges of the stationary blade 21 and the moving blade 22, and continuous gaps 21b and 22b are provided on a suitable location on an internal surface of each saw-tooth on the respective cutting edges 21a and 22a of the stationary blade 21 and the moving blade 22. The gaps 21b and 22b can be in the shape of a semicircle, a triangle, or a square.

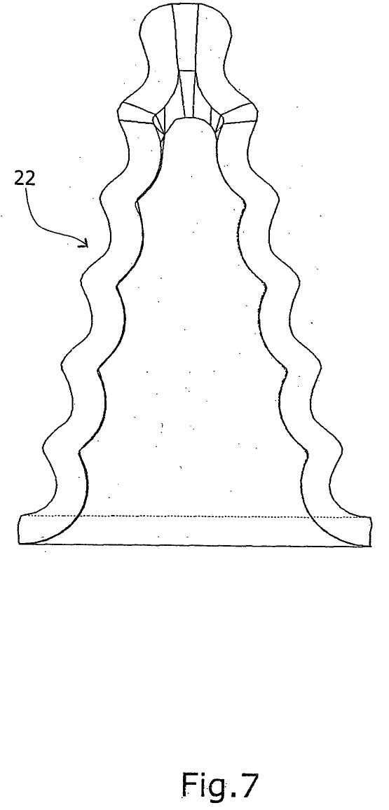

Referring to FIG. 7, when using the above structure, and when the moving blade 22 continuously makes crossover displacements with the stationary blade 21, a hair 2 enters the cutting edges 21a and 22a of the shearing tool set 20 and is temporarily kept by a holding space formed by the gaps 21b and 22b configured on the respective cutting edges 21a and 22a of the stationary blade 21 and the moving blade 22. In this way, the hair 2 will no longer slide forward from the cutting edges 21a and 22a and become dislocated.

In summary, the present invention provides continuous gaps on the cutting edges of the shearing tool set 20, thereby forming temporary holding spaces for hair during shearing. The advantages of the present invention are the convenience in using it and better shearing effects than those of conventional shearing tool sets.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An electric hair clipper, provided with a shearing tool set formed on a front end of a housing, comprising: a stationary blade and a vibratory base having a moving blade, wherein the stationary blade is positioned at a suitable location on an exterior of the vibratory base such that the moving blade forms a superimposed structure on the stationary blade, whereas the vibratory base is driven by a motor inside the housing such that the moving blade and the stationary blade form cross-over displacements, wherein triangular saw-tooth cutting edges are configured at front edges of the moving blade and the stationary blade, and continuous gaps are provided on a suitable location on an internal surface of each saw-tooth on the respective cutting edges of the stationary blade and the moving blade, wherein the continuous gaps are in the shape of semi-circles, wherein a bottom surface of the moving blade tapers to form a smaller moving blade top surface and a bottom surface of the stationary blade tapers to form a smaller stationary blade top surface.

2-4. (canceled)
